(19) United States
(12) Patent Application Publication
(10) Pub. No.: US 2007/0273650 A1
(43) Pub. Date: Nov. 29, 2007

(54) Method of data transferring for bluetooth mouse

(75) Inventors: Hsin-Ju Wu, Hsinchu (TW); Hung-Mao Chang, Hsinchu (TW); Hsin-Ling Chu, Hsinchu (TW); Albert Chen, Hsinchu (TW)

Correspondence Address: BIRCH STEWART KOLASCH & BIRCH, PO BOX 747, FALLS CHURCH, VA, 22040-0747, US

(73) Assignee: Integrated System Solution Corp.

(21) Appl. No.: 11/439,991

(22) Filed: May 25, 2006

(51) Int. Cl. G09G 5/08

(52) U.S. Cl. 345/163

(57) ABSTRACT

The present invention discloses a method of data transferring for a Bluetooth mouse, wherein the time interval between data transmissions is adjusted according to the coordinate displacement values created by the movements of the mouse; before displacement detection and data transference, the method firstly checks whether the current data transfer rate is at a higher value or a lower value and then determines whether the time interval with a higher transfer frequency is to be reduced to the time interval with a lower transfer frequency.

### BACKGROUND OF THE INVENTION

1. Field of the Invention

The present invention relates to a method of data transferring for a mouse, particularly to a method of data transferring for a Bluetooth mouse.

2. Description of the Related Art

Commonly, a mouse transmits the data packets of coordinate displacement values to a computer at a fixed rate, and the computer presents the motion locus of the mouse on the screen. When the mouse moves slowly, the locus presented on the screen can more closely resemble the trajectory of the mouse's motion. However, when the mouse moves rapidly, the locus presented on the screen seems segmented. Refer to FIG. 1a and FIG. 1b for the circles respectively drawn slowly and rapidly with a mouse. Such a phenomenon results from the fixed transfer rate of the data packets. For example, when a circle is drawn by a mouse at a higher speed, ten packets of coordinate displacement data are transmitted to the computer; when a circle is drawn by the mouse at a lower speed (Suppose the motion of the mouse is three times slower than the abovementioned one), thirty packets of coordinate displacement data will be transmitted to the computer. Thus, the fast-drawn circle appears like a regular ten-sided polygon, and the slowly-drawn circle appears like a regular thirty-sided polygon. The regular thirty-sided polygon more closely resembles a circle than the regular ten-sided polygon. If the mouse transmits the data packets at a higher transfer rate, more data will be received within a unit of time, and the presented circle will be smoother.

However, the data transfer rate of the Bluetooth mouse is not regulated by the current Bluetooth standard but determined by the manufacturers themselves. Thus, it becomes an important topic for the Bluetooth mouse to effectively transmit data without influencing the existing performance of the mouse. The data transfer rate of a wired USB mouse is commonly 125 HID (Human Interface Device) packets per second (or a packet per 8 milliseconds). However, for saving power, the data transfer rate of a wireless Bluetooth mouse is usually less than 100 HID packets per second. Refer to FIG. 2 a flowchart of the conventional data transfer method whereby the mouse transmits data packets to a computer. In Step S11, a mouse begins to operate and obtains the coordinate displacement values of its movement and transforms the coordinate displacement values into a HID packet and then transmits the HID packet to a computer. In Step S12, the mouse suspends the displacement detection and data transference for a time interval and then begins to execute Step S11 again. Any wired/wireless mouse, which transmits data packets at a fixed rate, is advantaged in simple circuitry. However, the fixed data transfer rate has the likelihood of inducing figure distortion. When a mouse is moved rapidly, i.e. when the motion of the mouse generates a great displacement within a very short instant, the locus presented on the screen is hard to closely imitate the physical trajectory of the mouse's motion and will be of serious aliasing; for example, when the mouse draws a curve or a circle rapidly, the curve presented on the screen appears to be segmented, and the circle presented on the screen appears to be a polygon.

### SUMMARY OF THE INVENTION

The primary objective of the present invention is to provide a method of data transferring for a Bluetooth mouse, wherein the transfer rate of data packets is adjusted according to the coordinate displacement values created by the movements of the mouse; the mouse can dynamically respond to the speed of the user's movement and adjust the data transfer rate so that the figure presented on the screen of the computer can more closely imitate the physical trajectory drawn by the user.

Another objective of the present invention is to provide a method of data transferring for a Bluetooth mouse, wherein the method firstly judges whether the time interval between the last data transmission and the second last data transmission is of a smaller value or a greater value (i.e. whether the data packets are transmitted at a higher speed or a lower speed) and then determines whether to change the data transfer rate lest the operational burden and power consumption of the microprocessor inside the mouse be adversely influenced.

To achieve the abovementioned objectives, the method of data transferring for a Bluetooth mouse according to one embodiment of the present invention comprises: obtaining a first pair of displacement values, transforming the first pair of displacement values into a data packet, and transmitting the data packet to a computer via a wireless transmission link; performing a comparison to determine whether either of the absolute values of the first pair of the displacement values is greater than a critical value, and if the result of the comparison is “Yes”, assigning a first value to the time interval between obtaining and transmitting the first pair of displacement values and obtaining and transmitting the next pair of displacement values, and if the result of the comparison is “No”, assigning a second value to the time interval; and reading the first value or the second value of the time interval, and after the time interval has passed, obtaining a second pair of displacement values, transforming the second pair of displacement values into a data packet, and transmitting the data packet to the computer.

Further, according to another embodiment, the method of data transferring for a Bluetooth mouse of the present invention comprises: obtaining a first pair of displacement values, transforming the first pair of displacement values into a data packet, and transmitting the data packet to a computer via a wireless transmission link; determining whether the value of the time interval between transmissions is equal to a predetermined value, and if the value of the time interval between transmissions is equal to the predetermined value, performing a comparison to determine whether either of the absolute values of the displacement values is greater than a critical value, and if the result of the comparison is “Yes”, assigning a first value to the time interval between transmissions, and if the result of the comparison is “No”, assigning a second value to the time interval between transmissions, and reading the value of the time interval between transmissions, and after the time interval has passed, obtaining a second pair of displacement values, transforming the second pair of displacement values into a data packet, and transmitting the data packet to the computer; if the value of the time interval between transmissions is not equal to the predetermined value, adding a value to a cumulative integer variable, and judging whether the value of the cumulative integer variable is greater than a constant, and if the value of the cumulative integer variable is not greater than the constant, reading the value of the time interval, and after the time interval has passed, obtaining a second pair of displacement values, transforming the second pair of displacement values into a data packet, and transmitting the data packet to the computer, and if the value of the cumulative integer variable is greater than the constant, resetting the value of the cumulative integer variable to be zero; performing a comparison to determine whether either of the absolute values of the displacement values is greater than a critical value, and if the result of the comparison is “Yes”, assigning a first value to the time interval between transmissions, and if the result of the comparison is “No”, assigning a second value to the time interval between transmissions; and reading the value of the time interval between transmissions, and after said time interval has passed, obtaining a second pair of displacement values, transforming the second pair of displacement values into a data packet, and transmitting the data packet to the computer.

Other advantages of the present invention will become apparent from the following description taken in conjunction with the accompanying drawings wherein are set forth, by way of illustration and example, certain embodiments of the present invention.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1a is a diagram showing the circular locus presented on the computer screen, wherein the circle is drawn by a mouse at a lower speed, and the coordinate data is transmitted with the conventional data transfer method using a fixed transfer rate;

FIG. 1b is a diagram showing the circular locus presented on the computer screen, wherein the circle is drawn by a mouse at a higher speed, and the coordinate data is transmitted with the conventional data transfer method using a fixed transfer rate;

FIG. 2 is a flowchart of the conventional data transfer method whereby the mouse transmits data packets to a computer;

FIG. 3 is a flowchart of the method of data transferring for a Bluetooth mouse according to one embodiment of the present invention; and

FIG. 4 is a flowchart of the method of data transferring for a Bluetooth mouse according to another embodiment of the present invention.

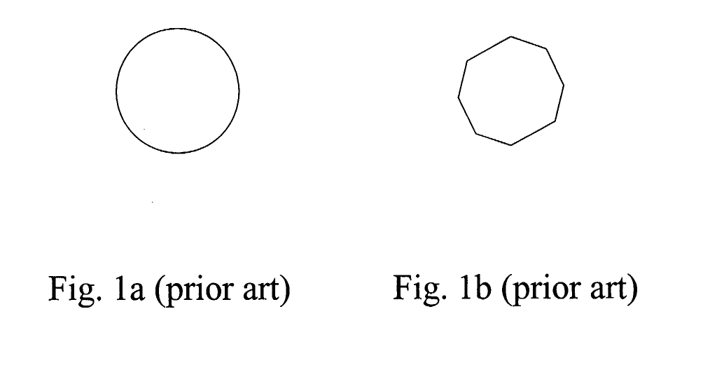

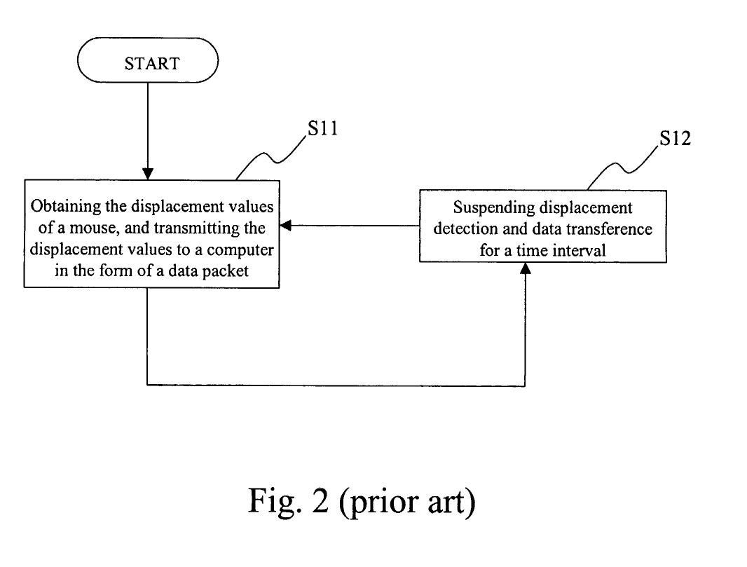

### DETAILED DESCRIPTION OF THE INVENTION

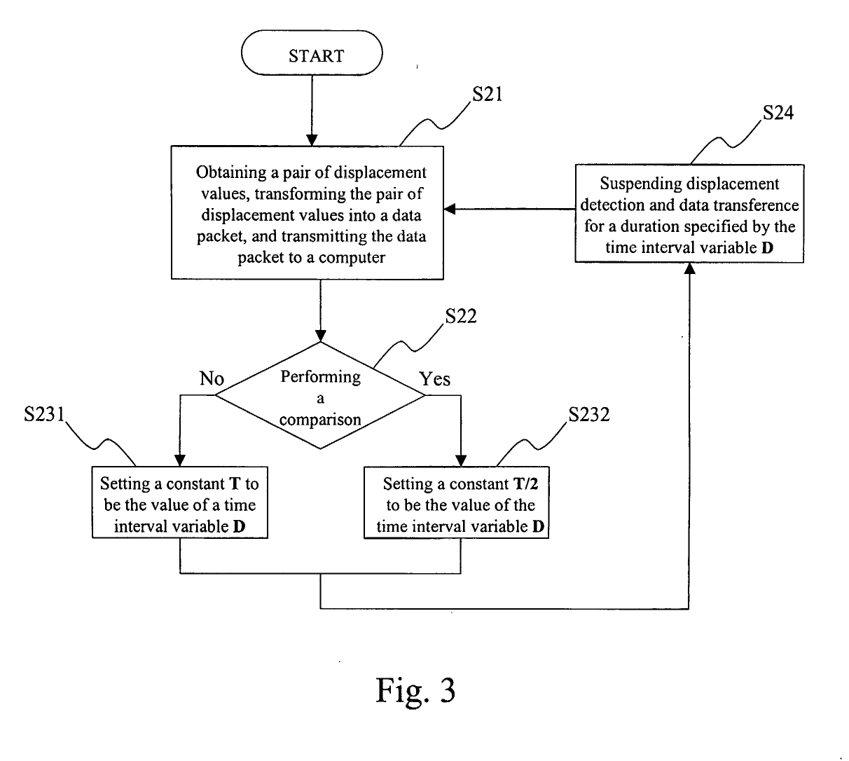

Refer to FIG. 3 a flowchart of the method of data transferring for a Bluetooth mouse according to one embodiment of the present invention. In Step S21, the displacement of a mouse is obtained and sent to a computer in the form of a data packet, i.e. a pair of coordinate displacement values (.X, .Y) of the mouse is obtained and transformed into a HID (Human Interface Device) packet, and then, the HID packet is transmitted to the computer, such as a personal computer or a notebook computer, via a wireless transmission link. In Step S22, a comparison is performed to determine whether either of the absolute values of the coordinate displacement values |.X| and |.Y| is greater than a critical value. If the result of the comparison is “No”, the process proceeds to Step S231, and the value of a time interval variable D is set to be a constant T for obtaining the next pair of coordinate displacement values (.X, .Y) of the mouse. If the result of the comparison is “Yes”, the process proceeds to Step S232, and the time interval variable D is set to be a constant T/2. In Step S24, the system receives the determined value of the time interval variable D, and the mouse suspends the displacement detection and data transference for a duration specified by the time interval variable D. After the duration specified by the time interval variable D has passed, the mouse is resumed to execute Step S21. In this embodiment, the wireless transmission link is a Bluetooth network, via which the HID packet is sent to the computer by a Bluetooth RF (Radio Frequency) module of the mouse; the coordinate displacement values (.X, .Y) are respectively the difference of the X coordinate values after and before a movement of the mouse and the difference of the Y coordinate values after and before the movement of the mouse, i.e. .X=X_{after}.X_{before} and .Y=Y_{after}.Y_{before}.

In this embodiment, the data transfer rate of the mouse is adjusted according to the current coordinate displacement values. Periodically, the mouse detects the coordinate displacement values (. X, .Y) and transmits a HID packet containing the .X and .Y values to the computer. When either of the absolute values of the coordinate displacement values |.X| and |.Y| is greater than a critical value K, the frequency of detecting .X and .Y is raised, i.e. the time interval between the detections of .X and .Y is shortened, and thus, the data transfer rate is increased. When both of the absolute values of the coordinate displacement values |.X| and |.Y| are smaller than the critical value, the detection frequency is restored to the original value, and thus, the data transfer rate is resumed to the normal value. Thereby, when the mouse is moving fast, the transfer rate of the data packet of the coordinate displacement values can be speeded up, and the computer will still present a smooth cursor locus; when the moving speed of the mouse is resumed to the normal speed, the data transfer rate can be restored to the original value.

In the abovementioned embodiment, the transfer rate of the data packet is adjusted according to the coordinate displacement values created by the planar movement of the mouse. Thereby, the mouse can dynamically respond to the movement of the user and adjust the data transfer rate so that the figure presented on the screen of the computer can more closely imitate the physical trajectory drawn by the user.

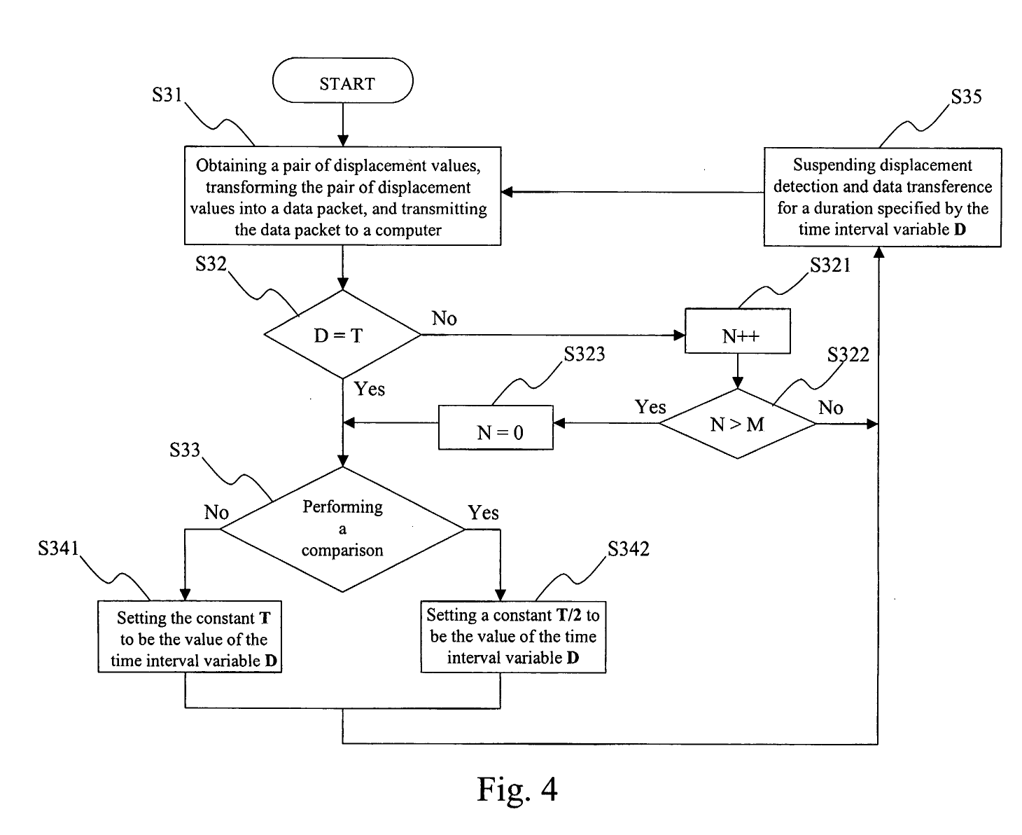

Refer to FIG. 4 a flowchart of the method of data transferring for a Bluetooth mouse according to another embodiment of the present invention. In Step S31, a pair of coordinate displacement values (.X, .Y) of a mouse is obtained and transformed into a HID (Human Interface Device) packet, and then, the HID packet is transmitted to a computer via a wireless transmission link. In Step S32, whether the value of a time interval variable D is a constant T is determined. If the value of the time interval variable D is the constant T, the process proceeds to Step S33 for determining whether either of the absolute values of the coordinate displacement values |.X| and |.Y| is greater than a critical value K. If none of the absolute values of the coordinate displacement values |.X| and |.Y| is greater than the critical value, the process proceeds to Step S341, and the value of the time interval variable D is set to be the constant T for obtaining the next pair of coordinate displacement values (.X, .Y) of the mouse. If either of the absolute values of the coordinate displacement values |.X| and |.Y| is greater than the critical value, the process proceeds to Step S342, and the value of the time interval variable D is set to be a constant T/2. After the value of the time interval variable D has been determined, the process proceeds to Step S35, and the system reads the determined value of the time interval variable D, and the mouse suspends the displacement detection and data transference for a duration specified by the time interval variable D; after the duration specified by the time interval variable D has passed, the mouse is resumed to execute Step S31. If the result of Step S32 is “No” and the value of the time interval variable D is not the constant T, the process proceeds to Step S321, and the value of an cumulative integer variable N accumulates. Next, the process proceeds to Step S322 for determining whether the value of the cumulative integer variable N is greater than a predetermined constant M. If the value of the cumulative integer variable N is not greater than the predetermined constant M, the process proceeds to Step S35, and the system reads the value of the time interval variable D, and the mouse suspends the displacement detection and data transference for a duration specified by the time interval variable D; after the duration specified by the time interval variable D has passed, the mouse is resumed to execute Step S31. If the value of the integer variable N is greater than the predetermined constant M, the process proceeds to Step S323, and the value of the cumulative integer variable N is reset to be zero. Next, the process proceeds to Step S33 for determining a value of the time interval variable D anew, and after the time interval has passed, Step S31 is executed. In this embodiment, the wireless transmission link is a Bluetooth network, via which the HID packet is transmitted to the computer by a Bluetooth RF (Radio Frequency) module of the mouse.

In this embodiment, the method of the present will check whether the current data transfer rate is at a higher value before the detection of the coordinate displacement values. If the current data transfer rate is at a higher value, the value of the cumulative integer variable N will be compared with a constant M to determine whether the current data transfer rate has been used for a period of time. If the value of the cumulative integer variable N is not greater than the constant M, it means that the data packets have not been transferred at the higher speed for a sufficient time yet; no matter what values of |.X| and |.Y| the mouse obtains, the data packets will be transferred at the higher speed with the time interval variable D=T/2 continuously. If the current data transfer rate is at a lower value with the time interval variable D being the normal value T, the increase of the data transfer rate is not limited by the abovementioned constant M. Therefore, in the present invention, the data transfer rate of the mouse can be arbitrarily raised from a lower value to a higher value; however, in the present invention, the drop of the data transfer rate from a higher value to a lower value is limited by the usage time of the higher transfer rate lest the data transfer rate of the mouse should drop from a higher value to a lower value immediately.

In the abovementioned embodiment, if the mouse moves fast for a very short period of time and slows down/stops abruptly, the data transfer rate of the mouse will be raised to a higher value and maintains at the higher value for an appropriate period of time before it is decreased lest the operational burden and power consumption of the microprocessor inside the mouse be influenced. Further, as the values of constants M and K have much to do with the power consumption and the complexity of the physical circuits of the mouse, they should be determined according to the requirements of the designers.

Briefly to speak, the present invention not only can dynamically adjust the data transfer rate according to the speed of the mouse, but also can protect the mouse against the increase of the microprocessor burden and power consumption resulting from the abrupt switching of the data transfer rate.

Those embodiments described above are to clarify the technical thoughts and characteristics of the present invention in order to enable the persons skilled in the art to understand, make, and use the present invention. However, it is not intended to limit the scope of the present invention, and any equivalent modification and variation according to the spirit of the present invention is to be also included within the scope of the present invention.

What is claimed is:

1. A method of data transferring for a Bluetooth mouse, comprising:
obtaining a first pair of displacement values (.X, .Y), transforming said first pair of displacement values into a data packet, and transmitting said data packet to a computer via a wireless transmission link;
performing a comparison to determine whether either of the absolute values of said displacement values (|.X| and |.Y|) is greater than a critical value; if the result of said comparison is yes, assigning a first value to the time interval between obtaining said first pair of displacement values and obtaining the next pair of displacement values; if the result of said comparison is no, assigning a second value to said time interval;
reading said first value or said second value of said time interval; after said time interval has passed, obtaining a second pair of displacement values, transforming said second pair of displacement values into a data packet, and transmitting said data packet to said computer.

2. The method of data transferring for a Bluetooth mouse according to claim 1, wherein said data packet is a HID (Human Interface Device) packet.

3. The method of data transferring for a Bluetooth mouse according to claim 1, wherein said wireless transmission link is a Bluetooth network.

4. The method of data transferring for a Bluetooth mouse according to claim 1, wherein said computer is a personal computer or a notebook computer.

5. The method of data transferring for a Bluetooth mouse according to claim 1, wherein said first value of said time interval is smaller than said second value of said time interval.

6. The method of data transferring for a Bluetooth mouse according to claim 1, wherein said displacement values (.X, .Y) are respectively the difference of the X coordinate values after and before a movement of said mouse and the difference of the Y coordinate values after and before said movement of said mouse, i.e. X=X_{after}.X_{before} and .Y=Y_{after}.Y_{before}.

7. A method of data transferring for a Bluetooth mouse, comprising:
obtaining a first pair of displacement values (.X, .Y), transforming said first pair of displacement values into a data packet, and transmitting said data packet to a computer via a wireless transmission link;
determining whether the value of a time interval between transmissions is equal to a predetermined value;
if said value of said time interval between transmissions is equal to said predetermined value, performing a comparison to determine whether either of the absolute values of said displacement values (|.X| and |.Y|) is greater than a critical value; if the result of said comparison is yes, assigning a first value to said time interval between transmissions; if the result of said comparison is no, assigning a second value to said time interval between transmissions;
if said value of said time interval between transmissions is not equal to said predetermined value, adding a value to a cumulative integer variable, and checking whether the value of said cumulative integer variable is greater than a constant; if the value of said cumulative integer variable is greater than said constant, resetting said cumulative integer to zero and performing a comparison to determine whether either of the absolute values of said displacement values (|.X| and |.Y|) is greater than said critical value; if the result of said comparison is yes, assigning a first value to said time interval between transmissions; if the result of said comparison is no, assigning a second value to said time interval between transmissions;
if said value of said time interval between transmissions is not equal to said predetermined value, adding a value to said cumulative integer variable, and checking whether the value of said cumulative integer variable is greater than said constant; if the value of said cumulative integer variable is not greater than said constant, maintaining said value of said time interval between transmissions; and
reading said value of said time interval between transmissions, and after said time interval has passed, obtaining a second pair of displacement values, transforming said second pair of displacement values into a data packet, and transmitting said data packet to said computer.

8. The method of data transferring for a Bluetooth mouse according to claim 7, wherein said second value of said time interval is equal to said predetermined value and is greater than said first value of said time interval.

9. The method of data transferring for a Bluetooth mouse according to claim 7, wherein said data packet is a HID (Human Interface Device) packet.

10. The method of data transferring for a Bluetooth mouse according to claim 7, wherein said wireless transmission link is a Bluetooth network.

11. The method of data transferring for a Bluetooth mouse according to claim 7, wherein said computer is a personal computer or a notebook computer.

12. The method of data transferring for a Bluetooth mouse according to claim 7, wherein said displacement values (.X, .Y) are respectively the difference of the X coordinate values after and before a movement of said mouse and the difference of the Y coordinate values after and before said movement of said mouse, i.e. .X=X_{after}.X_{before} and .Y=Y_{after}.Y_{before}.
